(19) United States
(12) Patent Application Publication
(10) Pub. No.: US 2009/0104971 A1
(43) Pub. Date: Apr. 23, 2009

(54) Slot Machine

(75) Inventor: Kazumasa YOSHIZAWA, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: ARUZE CORP., Tokyo (JP)

(21) Appl. No.: 12/252,922

(22) Filed: Oct. 16, 2008

(30) Foreign Application Priority Data
Oct. 19, 2007 (JP) 2007-272847

(51) Int. Cl. A63F 9/24; A63F 13/00

(52) U.S. Cl. 463/20

(57) ABSTRACT

During a base game, a processor displays symbols in a scrolled manner in accordance with a symbol arrangement order defined as first array in which symbols of various kinds are positioned randomly without regularity. During a free game, the processor changes symbol arrangement order of symbols on each reel from first array to second array so that symbols of a kind are positioned next to each other. The processor displays symbols in accordance with a symbol arrangement order defined as second array in a scrolled manner for each reel in a state that all the reels are rotated synchronously.

### CROSS-REFERENCE TO RELATED APPLICATIONS

This application is based upon and claims a priority from the prior Japanese Patent Application No. 2007-272847 filed on Oct. 19, 2007, the entire contents of which are incorporated herein by reference.

### BACKGROUND

1. Field

The slot machine according to one or more aspects of the present invention relates to a slot machine that executes a free game, in addition to a base game, when a predetermined condition has been satisfied during the base game.

2. Description of Related Art

Conventionally, in a slot machine, which is one type of a gaming machine, a game is started by inserting coins, or the like, in the gaming machine. In the game, a symbol column is variably displayed in a predetermined area in the gaming machine, and after the lapse of a predetermined period of time, the symbol column is stopped and displayed. Then, a payout is awarded based on a combination of the symbols thus stopped.

Generally, whether or not a winning combination for which a payout is awarded is established is determined depending on whether a predetermined number of the same kind of symbols (for instance, “CHERRY” and “7”) are positioned along a pay line set in advance. Conventionally, if a predetermined number or more of the same kind of symbols are positioned, a payout was also awarded based on the number of symbols thus positioned, irrespective of the pay line.

A large number of conventional slot machines execute two kinds of games, including a base game and a free game. The base game is executed by consumption of a gaming value (coins, credits, etc) corresponding to a bet amount. Alternatively, the free game is executed without consumption of any a gaming value corresponding to the bet amount. Switching from the base game to the free game occurs if a predetermined condition is satisfied, such as the case that a specific symbol(s) is(are) stopped and displayed during the base game. Switching from the free game to the base game occurs if a predetermined condition is satisfied, such as the case that a free game has been carried out by a predetermined number of times.

Further, in a conventional slot machine, the sense of expectancy of the player for a free game is improved by making it easier to establish a combination for which payout is awarded in the free game, as compared to the case of the base game. In such a conventional slot machine, the symbol column which is positioned on the reel in the free game is changed from the one used in the base game, and the number of kinds of symbols is reduced from 8 kinds to 5 kinds. Thus, the probability for establishment of a combination for which a payout is awarded during the free game can be apparently increased.

In the above mentioned conventional slot machine, in both a free game and a base game, the arrangement order of symbols on each of the reels is irregular-and-mix-mannered arrangement of different kinds of symbols. In a slot machine, a content of prize to be awarded is generally determined depending on a combination of plural symbols positioned on its display. Accordingly, a player generally has to grasp a symbol combination positioned on the displayed when rotation of reels is stopped so as to judge presence and absence of a combination to which a prize is awarded. In the said conventional slot machine, however, plural kinds of plural symbols are positioned on the display in an irregular manner. Therefore, it took a long time for a player to judge presence and absence of a combination to which a prize is awarded.

Especially, in case of playing a game with some kinds of scatter symbols in which a content of a prize is determined depending on the number of scatter symbols of a kind positioned on a display regardless of pay lines, it is necessary to count the number of scatter symbols of each kind for judging presence and absence of a combination to which a prize is awarded when rotation of reels is stopped. Therefore, in case plural kinds of scatter symbols are positioned on a display in irregular manner, a player has had difficulty in judging presence and absence of a combination to which a prize is awarded.

The present invention has been made to provide a slot machine which makes up symbol columns in a special arrangement order such that symbols of a kind are positioned next to each other. Thereby, the special arrangement order of symbols enables a player to judge presence and absence of a combination to which a prize is awarded at ease and enhances the sense of expectancy of the player with respect to a free game.

### SUMMARY

Therefore, in order to achieve the object, according to a slot machine of the present invention encompassing one or more aspects thereof, there is provided a slot machine comprising a display that displays a plurality of symbols and a processor. The processor displays symbols in a scrolled manner during a base game wherein the symbols are arranged in accordance with a symbol arrangement order defined as first array. The processor executes a free game if a predetermined condition is satisfied during a base game. The processor changes the symbol arrangement order from the first array to second array wherein symbols of each identical kind are positioned next to each other. Furthermore, the processor displays symbols in a scrolled manner during a free game wherein the symbols are arranged in accordance with a symbol arrangement order defined as second array. During a free game, each symbol column is configured in accordance with the special symbol arrangement order such that symbols of each identical kind are positioned next to each other. Therefore, the special symbol arrangement order enables the player to easily judge presence and absence of a combination which awards a prize. Especially, in case that scatter symbols are employed as symbols of the slot machine, an apparent probability that symbols of the same kind are displayed is heightened. Thereby, the sense of expectancy of the player of a free game is improved.

According to the present invention encompassing one or more aspects, there is provided a slot machine. The slot machine comprises: plural reels each of which displays plural kinds of symbols in a scrolled manner and stops and displays any one or some of plural symbols; a display that displays a the plural reels; and a processor. The processor displays symbols on the plural reels in a scrolled manner during a base game wherein the symbols are arranged in accordance with a symbol arrangement order that is defined as first array. The processor executes a free game if a predetermined condition is satisfied during a base game. The processor changes the symbol arrangement order from the first array to second array wherein symbols of each identical kind are positioned next to each other. Furthermore, the processor rotates all the plural reels synchronously during a free game in a state that symbols of each identical kind are positioned next to each other among the plural reels and displays symbols on the plural reels in a scrolled manner during a free game wherein the symbols are arranged in accordance with a symbol arrangement order that is defined the second array. Symbol columns are displayed in a scrolled manner and also stopped and displayed in a state that symbols of each identical kind are collected over the reels. Therefore, the above such symbol display manner enables the player to easily judge presence and absence of a combination which awards a prize. Furthermore, by displaying symbols in a scrolled manner and rotating respective reels synchronously, an apparent probability that symbols of the same kind are displayed is heightened. Thereby, the sense of expectancy of the player of a free game is improved.

According to the present invention encompassing one or more aspects, there is provided a slot machine. The slot machine comprises: plural reels each of which displays plural kinds of symbols in a scrolled manner and stops and displays any one or some of plural symbols; a display that displays a the plural reels; and a processor. The processor displays a frame which encloses one or plural symbols displayed on the display. The processor also displays symbols on the plural reels in a scrolled manner during a base game wherein the symbols are arranged in accordance with a symbol arrangement order that is defined as first array. The processor executes a free game if a predetermined condition is satisfied during a base game. The processor changes the symbol arrangement order from the first array to second array wherein symbols of each identical kind are positioned next to each other. Furthermore, the processor rotates all the plural reels synchronously during a free game in a state that symbols of each identical kind are positioned next to each other among the plural reels and displays symbols on the plural reels in a scrolled manner during a free game wherein the symbols are arranged in accordance with a symbol arrangement order that is defined the second array. Still further, the processor awards a prize depending on symbols stopped and displayed within the frame. Since a prize is awarded depending on symbols positioned within the displayed frame, the above such symbol display manner offers various amusement effects that involve the frame in addition to positioning of symbols.

### BRIEF DESCRIPTION OF THE DRAWINGS

The accompanying drawings, which are incorporated in and constitute a part of this specification illustrate embodiments of the invention and, together with the description, serve to explain the objects, advantages and principles of the invention.

FIG. 1 is an explanatory view showing characteristic part of a slot machine according to a first embodiment of the present invention;

FIG. 2 is a perspective view showing an outer appearance of the slot machine according to the first embodiment of the present invention;

FIG. 3 is a front view showing a symbol display portion of the slot machine according to the first embodiment of the present invention;

FIG. 4 is a table showing variety of symbols and payouts which are used in the slot machine according to the first embodiment of the present invention;

FIG. 5 shows symbol columns of respective reels which are used in the slot machine according to the first embodiment of the present invention;

FIG. 6 is a block diagram showing an internal configuration of an entirety of the slot machine according to the first embodiment of the present invention;

FIG. 7 is a block diagram showing an internal configuration of a sub-control board installed in a slot machine according to the first embodiment of the present invention;

FIG. 8 is an explanatory view showing a base game and a free game which are executed in the slot machine according to the first embodiment of the present invention;

FIG. 9 is a flowchart showing a main control process program executed in a slot machine according to first embodiment of the present invention;

FIG. 10 is a flowchart showing a main game process program executed in the slot machine according to first embodiment of the present invention;

FIG. 11 is a flowchart showing a free game process program executed in the slot machine according to first embodiment of the present invention;

FIG. 12 is a front view showing a symbol display portion of a slot machine according to a second embodiment;

FIG. 13 is a flowchart showing a free game process program executed in the slot machine according to the second embodiment of the present invention;

FIG. 14 is a view for explaining a frame-enlarging/narrowing process executed in the slot machine according to the second embodiment of the present invention;

FIG. 15 is a flowchart showing a free game process program executed in a slot machine according to a third embodiment of the present invention;

FIG. 16 is a flowchart showing a frame-enlarging/narrowing process executed in the slot machine according to the third embodiment of the present invention; and

FIG. 17 is a perspective view showing an outer appearance of a slot machine according to another embodiment of the present invention;

### DETAILED DESCRIPTION

The various aspects summarized previously may be embodied in various forms. The following description shows by way of illustration of various combinations and configurations in which the aspects may be practiced. It is understood that the described aspects and/or embodiments are merely examples, and that other aspects and/or embodiments may be utilized and structural and functional modifications may be made, without departing from the scope of the present disclosure.

It is noted that various connections are set forth between items in the following description. It is noted that these connections in general and, unless specified otherwise, may be direct or indirect and that this specification is not intended to be limiting in this respect.

A slot machine according to one or more aspects of the invention will be described in detail with reference to the drawings based on an embodiment embodying one or more aspects of the invention. However, it is appreciated that one or more aspects of the present invention may be embodied in distributable (via CD and the like) or downloadable software games, console games, and the like. In this regard, the slot machine may be a virtual slot machine that is displayed on a multi-purpose computer and/or dedicated kiosk. Aspects of the invention are described by way of hardware elements. However, it is appreciated that these elements may also be software modules that are executable in a computer. The software modules may be stored on a computer readable medium, including but not limited to a USB drive, CD, DVD, computer-readable memory, tape, diskette, floppy disk, and the like. For instance, aspects of the invention may be embodied in a JAVA-based application or the like that runs in a processor or processors. Further, the terms “CPU”, “processor”, and “controller” are inclusive by nature, including at least one of hardware, software, or firmware. These terms may include a portion of a processing unit in a computer (for instance, in multiple core processing units), multiple cores, a functional processor (as running virtually on at least one of processor or server, which may be local or remote). Further, in network-based gaming systems, the processor may include only a local processor, only a remote server, or a combination of a local processor and a remote server.

It is contemplated that one or more aspects of the invention may be implemented as computer executable instructions on a computer readable medium such as a non-volatile memory, a magnetic or optical disc. Further, one or more aspects of the invention may be implemented with a carrier signal in the form of, for instance, an audio-frequency, radio-frequency, or optical carrier wave.

Next, a detailed description will be given on first to third embodiments relating to a slot machine according to the present invention, while referring to the accompanying drawings.

### First Embodiment

First, a slot machine 1 according to the first embodiment will be described in detail while referring to the drawings. The slot machine according to the first embodiment to be described hereinafter is a so-called video slot machine which has an image display device such as a liquid crystal display and in which a game is played by causing various kinds of symbol images to be displayed onto the image display device.

The slot machine according to the present invention carries out either of two types of game modes. These two game modes include a base game in which gaming values are consumed in accordance with a bet amount on which a bet was placed by the player; and a free game which is carried out without the consumption of any gaming values. The award of a payout during the game is conditioned by the establishment of a predetermined winning combination through the displayed symbols (more specifically, positioning of a predetermined number or more of same symbols on the display). In particular, the slot machine according to the present invention is characterized by the point that arrangement manner of symbols on symbol columns, scroll-displayed along rotation of reels, is changed such that symbols of a kind are positioned next to each other during a free game.

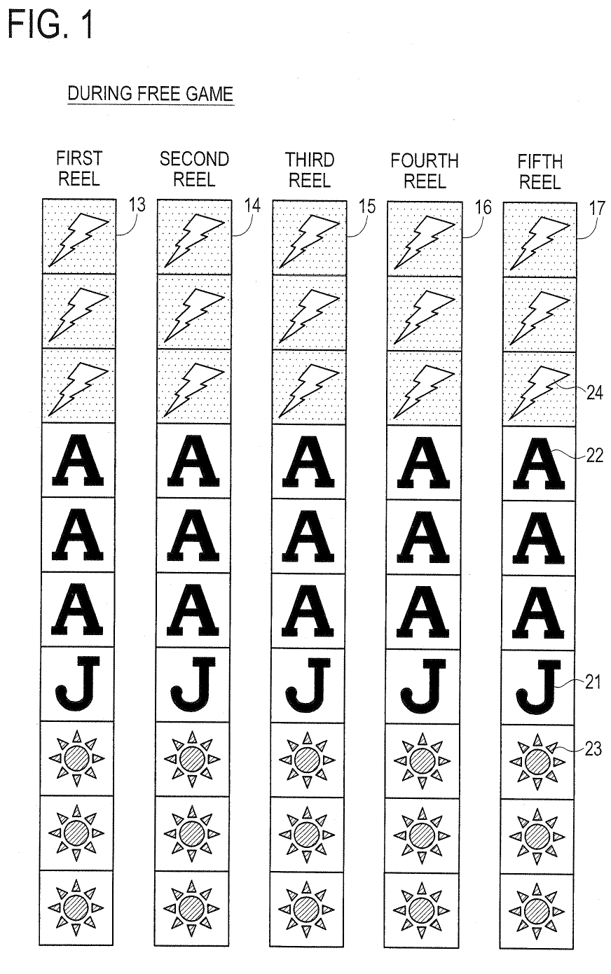

For instance, FIG. 1 shows an example to apply the inventive symbol arrangement changing manner to the slot machine according to the first embodiment equipped with five reels 13 through 17 on its display. When a base game is started and a condition to shift to a free game is satisfied in the slot machine, symbol arrangement order of symbol columns on the respective symbol columns 13 through 17 is changed so that symbols of each kind (in FIG. 1, four of kinds, namely, “JACK” symbol 21, “ACE” symbol 22, “SUN” symbol 23 and “THUNDER” symbol 24) are made to adjoin. Then, a free game is executed with the state that the symbol-arrangement-order-changed symbol columns are scroll-displayed.

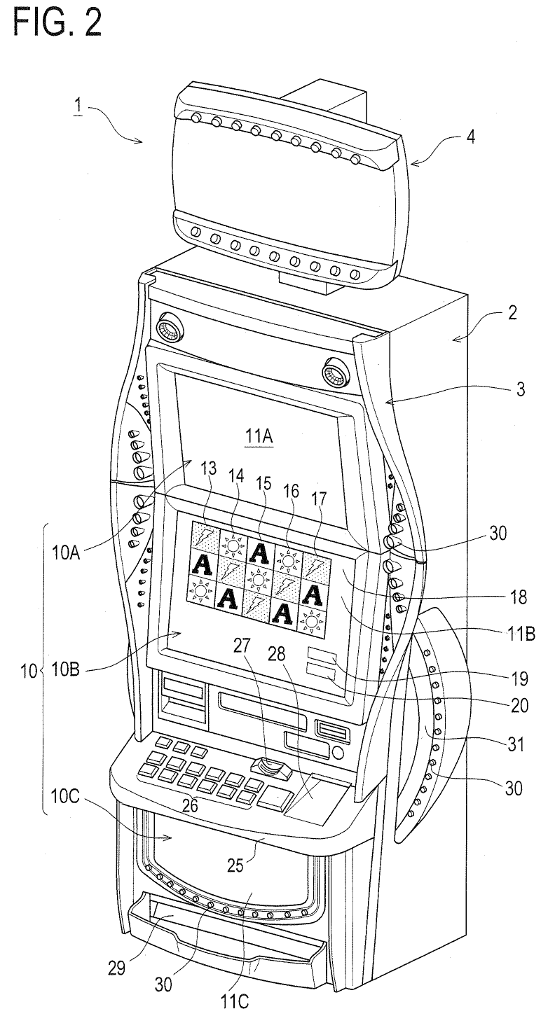

Hereinafter, a schematic configuration of the slot machine 1 according to the first embodiment will be described based on FIG. 2. FIG. 2 is a perspective view showing an outer appearance of the slot machine 1 according to the first embodiment.

The slot machine 1 according to the first embodiment is an upright-type slot machine positioned in a gaming arcade such as a casino or the like. This slot machine 1 has a cabinet 2, a main door 3 provided at a front face of the cabinet 2, and a topper effect device 4 arranged at an upper side of the cabinet 2.

The cabinet 2 is a housing portion that houses electrical or mechanical components. These electrical or mechanical components are used in execution of a predetermined game aspect.

The main door 3 has an upper display portion 10A, a mid-stage variable display portion 10B and a lower display portion 10C, functioning as a display portion 10 that displays information with respect to the game. The upper display portion 10A has an upper liquid crystal panel 11A which is arranged at an upper side of the variable display portion 10B. The upper liquid crystal panel 11A displays, for instance, effect images, an introduction to the game contents, explanation of game rules, payout tables and the like. The lower display portion 10C is arranged at a lower side of the variable display portion 10B and has a plastic panel 11C onto which an image has been printed. This plastic panel 11C is lit up with a backlight.

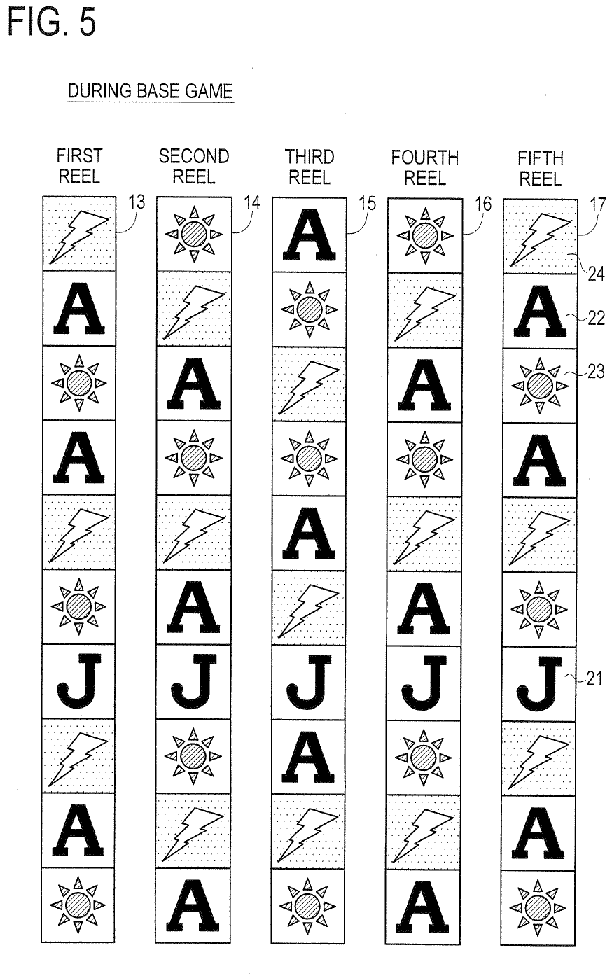

The variable display portion 10B that displays an execution state of the game has a main liquid crystal panel 11B constituted of a heretofore known transparent liquid crystal panel which is fixedly mounted to the main door 3. Here, the main liquid crystal panel 11B is constituted of a heretofore known liquid crystal panel and has a symbol display portion 12 which comprises a 3×5 matrix of symbol display areas. The symbol display portion 12 is constituted of five reels 13 through 17 which are used for a base game. During a base game, each of the reels 13 through 17 displays a symbol column in first array (see FIG. 5) that is previously determined in a scrolled manner. After the lapse of a predetermined period of time, three symbols are stopped and displayed in each reel. As a result, fifteen symbols are displayed in accordance with the progress of the game as will be described later, and a predetermined payout is awarded to the player in accordance with the combination of displayed symbols and credit amount (bet amount) thus betted. The number of reels in the base game may be three, and the number of displayed symbols is not limited to fifteen.

It is to be noted that each of the reels 13 through 17 changes symbol arrangement order during a free game as will be described later so that its symbols symbol arrangement order of respective symbol columns changes from the first array to second array that differs from the first array (see FIG. 1). It is further noted that, during a free game, all of the reels 13 through 17 are made to rotate synchronously in a state that inter-reel symbols are in a row line by line while they are being scrolled.

Further, a touch panel 18 is provided at a front face of the main liquid crystal panel 11B. The player can operate the touch panel 18 to input various types of commands.

At a right lower side of the variable display portion 10B, there are provided a payout amount display portion 19 and a credit amount display portion 20. The payout amount display portion 19 displays, as a payout amount, a payout amount to be awarded in the case the symbol combination which is stopped and displayed on the pay line in a base game is a predetermined combination, and an accumulated payout amount acquired in a free game. The credit amount display portion 20 displays the credit amount that the player currently possesses.

The cabinet 2 has an operation table 25 provided at a front face thereof, between the variable display portion 10B and the lower display portion 10C, and bulging out at the front side. On this operation table 25 are arranged various kinds of operation buttons 26, forming an operation unit that commands execution of the game. The buttons 26 include a BET button, a COLLECT button, a START button, a CASHOUT button and the like. The operation table 25 has a coin slot 27 adapted to accept coins, representing gaming values, inside the cabinet 2, and a bill slot 28 adapted to accept bills inside the cabinet 2.

The slot machine 1 according to the first embodiment employs coins, bills or electronic value information (credit) corresponding to these, as gaming values. The gaming values applicable to the present invention are not limited to those described above, and can include, for instance, medals, tokens, electronic money and tickets.

At a lowermost part of the cabinet 2, there is provided a coin tray 29 adapted to accept coins paid out from the hopper. Further, at a periphery of the cabinet 2 in the slot machine 1, there is arranged a light emitting portion 30 which lights up in a predetermined lighting fashion during the future game, if a win occurs. Further, at a side face of the cabinet 2 is provided a speaker 31 for audio output.

Further, the slot machine 1 has a topper effect device 4 provided at an upper side of the cabinet 2. This topper effect device 4 has a rectangular board shape and is arranged so as to be substantially parallel with the upper liquid crystal panel 11A of the upper display portion 10A.

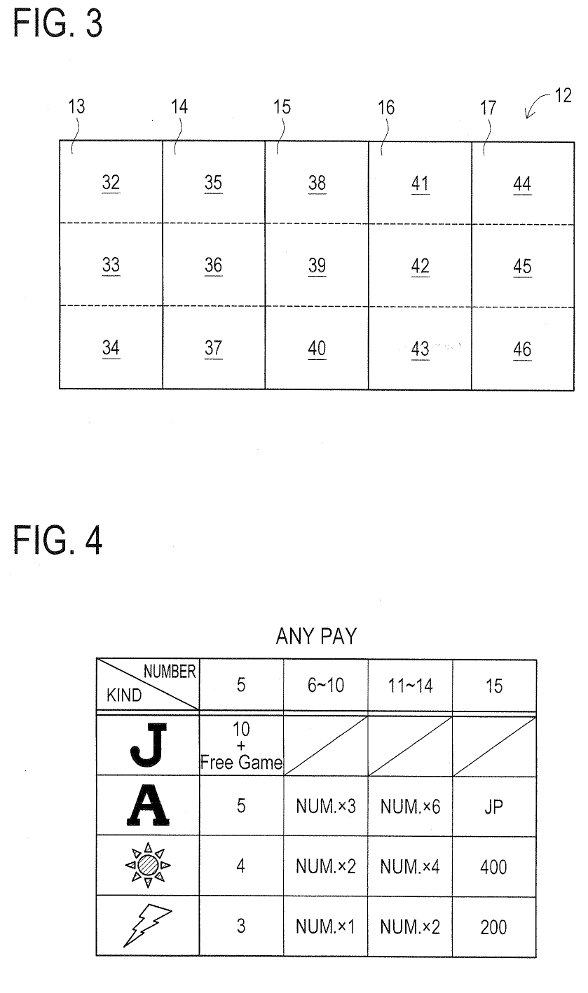

Next, a symbol display portion 12 provided in the main liquid crystal panel 11B and symbols 21 through 24 to be displayed on the symbol display portion 12 will be described based on FIGS. 1, 3 and 4. FIG. 3 is a front view showing a symbol display portion 12 in a base game and a free game carried out in the slot machine 1 according to the first embodiment. FIG. 4 is a view showing a list of contents for the various symbols and payouts which are used in the slot machine 1 according to the first embodiment for a base game and a free game.

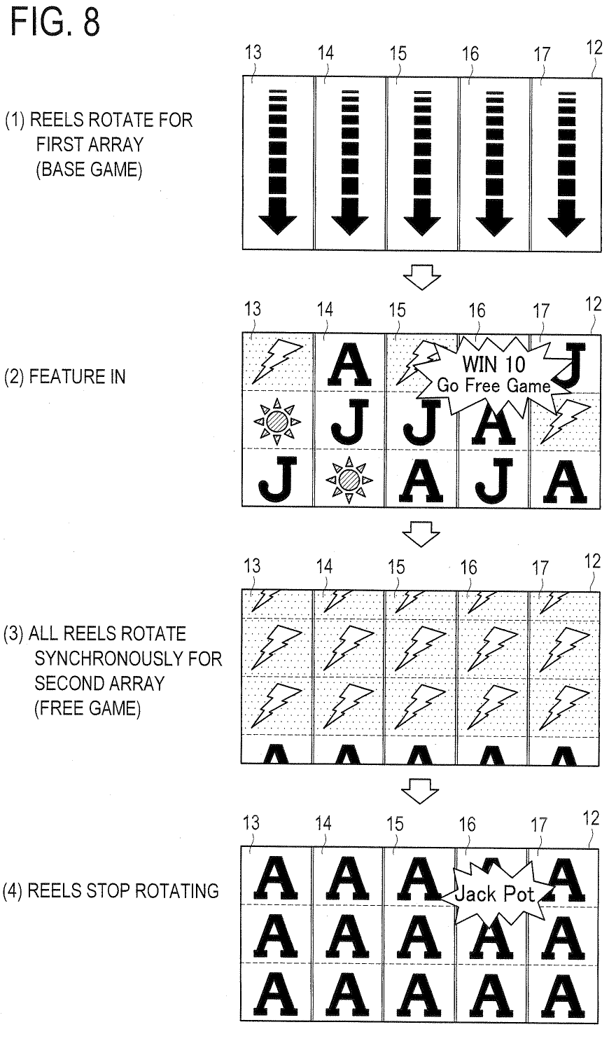

First, there will be described the symbol display portion 12 and symbols 21 through 24 displayed on the symbol display portion 12 during the execution of the base game. The symbol display area 12 in the base game, according to the first embodiment, is constituted of five reels 13 through 17. The reels 13 through 17 have symbol display areas 32 through 46, each symbol display area respectively displaying three symbols when the respective rotating reels 13 through 17 are stopped. In the first embodiment, there are used only four kinds of symbols: “JACK” symbol 21; “ACE” symbol 22; “SUN” symbol 23; and “THUNDER” symbol 24. All of those four kinds of symbols are four kinds of scatter symbols. When a game is started, the respective symbol display areas 32 through 46 each display one symbol (total fifteen symbols), as shown at (1) through (4) in FIG. 8. In the drawing, a dotted line is drawn to divide the respective symbol display areas 32 through 46, however, a configuration is possible where the dotted line is not shown.

In the slot machine 1 according to the first embodiment, symbol arrangement order of respective symbol columns displayed in a scrolled manner along rotation of reels 13 through 17 is made different between a base game and a free game. In FIG. 5, symbols are positioned on the reels 13 through 17 in accordance with symbol arrangement order defined as first array. In FIG. 1, symbols are positioned on the reels 13 through 17 in accordance with symbol arrangement order defined as second array.

As shown in FIG. 1 and FIG. 5, each of the reels 13 through 17 is comprised of ten symbols, namely, one “JACK” symbol 21, three “ACE” symbols 22, three “SUN” symbols 23, and three “THUNDER” symbols 24. During a base game, the symbols 21 through 24 are arranged in accordance with first array, i.e., arranged randomly without regularity. During a free game, the symbols 21 through 24 are arranged in accordance with second array in which symbols of each identical kind are positioned next to each other, i.e., the second array is a manner to position symbols with regularity.

Regarding respective symbol columns on the reels 13 through 17, a code number is assigned to each of the symbols in order from top one and code numbers are used in a lottery process so as to determine symbols to be positioned in the symbol display areas 32 through 46. In the slot machine 1 according to the first embodiment, symbol arrangement order is made different between a base game and a free game, as already explained. Assignment of code numbers to symbols is also made different between a base game and a free game.

Next, there will be described winning combinations determined with respective symbols 21 through 24 stopped and displayed on the symbol display portion 12, by referring to FIG. 4.

One “JACK” symbol 21 is included in each of the symbol columns on the reels 13 through 17. If five “JACK” symbols 21 are positioned on any areas of the symbol display areas 32 through 46, 10 credits are paid as a payout and predetermined number (e.g., five) of free games are executed in subsequent to termination of a base game as another payout.

Three “ACE” symbols 22 are included in each of the symbol columns on the reels 13 thorough 17. If five or more of “ACE” symbols 22 are positioned on any areas of the symbol display areas 32 through 46, one of the payouts as shown in FIG. 4 is paid. Particularly, if fifteen “ACE” symbols 22 are positioned on all the symbol display areas 32 through 46, credits currently accumulated as Jack Pot are paid out.

Three “SUN” symbols 23 and three “THUNDER” symbols 24 each are included in each of the symbol columns on the reels 13 thorough 17. If four or more of “SUN” symbols 23 are positioned on any areas of the symbol display areas 32 through 46, one of the payouts as shown in FIG. 4 is paid. If three or more of “THUNDER” symbols 24 are positioned on any of the symbol display areas 32 through 46, one of the payouts as shown in FIG. 4 is paid.

It is to be noted that the payout table shown in FIG. 4 indicates payouts in case the bet amount placed at the beginning of a game is one. Therefore, in case the bet amount is two or more, there is paid out amount corresponding to the product of a payout multiplied by the bet amount.

In the first embodiment, all of the symbols are comprised of scatter symbols. In case a predetermined number or more of symbols of a kind are positioned on any areas of the symbol display areas 32 through 46 regardless of paylines, it is regarded as winning of a prize and a payout is awarded. A prize, however, may be judged based on a payline. In case of using a payline, a payout is awarded when a predetermined number or more of symbols of a kind are positioned on a payline. Furthermore, it may be possible to award both a payout defined with a payline and a payout not influenced by a payline.

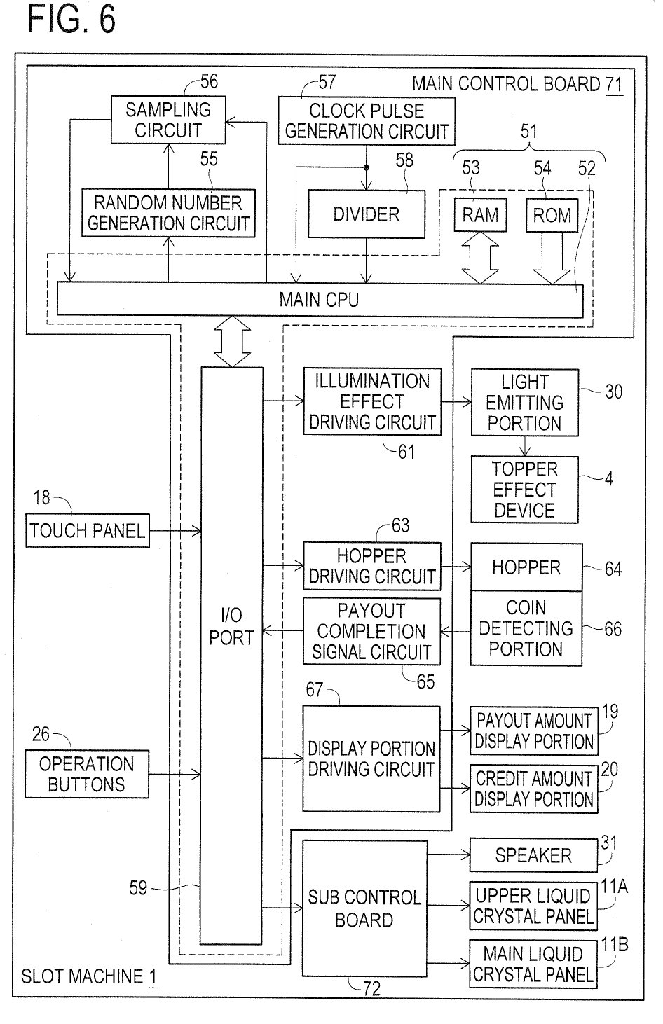

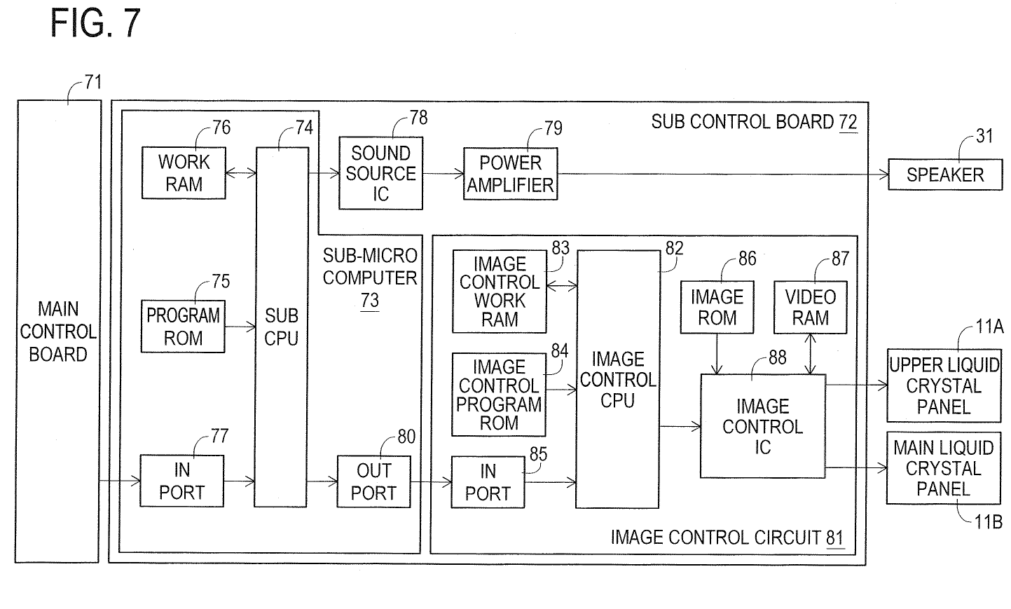

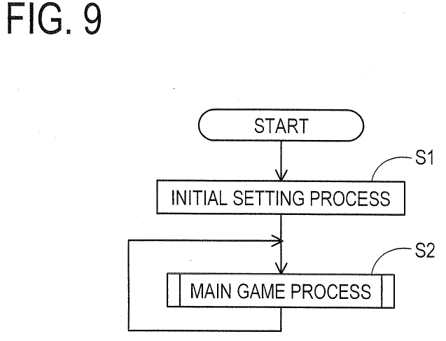

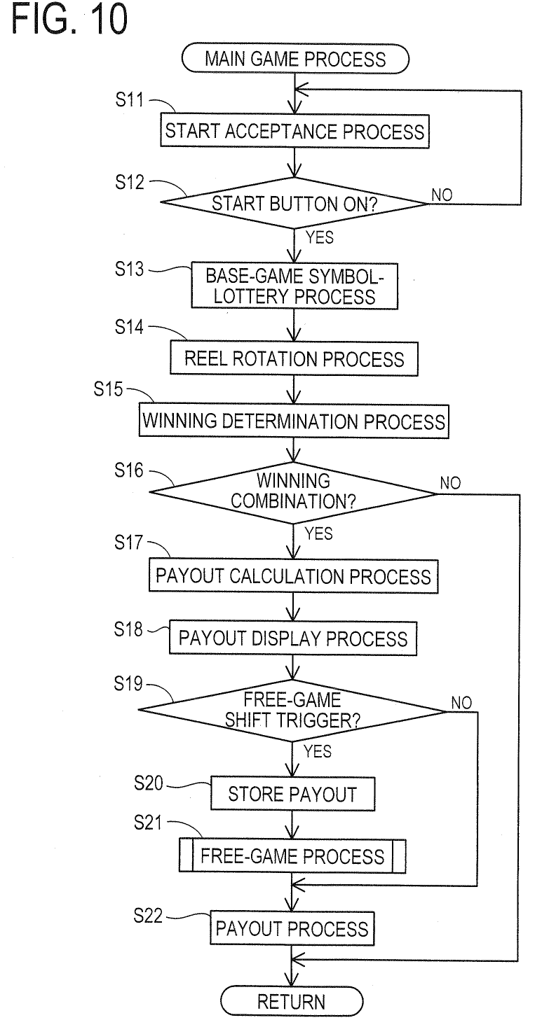

Next, the internal configuration of the above-mentioned slot machine 1 will be described while referring to FIG. 6 and FIG. 7. FIG. 6 is a block diagram showing an internal configuration of the entire slot machine 1. As shown in FIG. 7, the slot machine 1 has a plurality of constituent elements arranged around a main control board 71 including a controller 51 that executes control programs that will be described later (FIG. 9 through FIG. 11). The main control board 71 has a controller 51, a random number generation circuit 55, a sampling circuit 56, a clock pulse generation circuit 57, a divider 58, an illumination effect driving circuit 61, a hopper driving circuit 63, a payout completion signal circuit 65 and a display portion driving circuit 67.

The controller 51 has a main CPU 52, a RAM 53 and a ROM 54. The main CPU 52 operates in accordance with the programs stored in the ROM 54 and performs signal input and output with respect to the other constituent elements through an I/O port 59. Specifically, the main CPU 53 controls the operation of the entire slot machine 1. The RAM 53 stores data and programs to be used when the main CPU 52 is operating. For instance, the RAM 53 temporarily retains the random number values which have been sampled by the sampling circuit 56 after the game has started. The RAM 53 stores code numbers corresponding to the respective reels 13 through 17. The ROM 54 stores various types of programs that will be executed by the main CPU 52, as well as permanent data.

More particularly, the programs stored in the ROM 54 include game programs and game system programs (hereinafter referred to as game programs or the like). Further, the game programs include a lottery program as will be described later.

The lottery program is used to determine the code number for the respective reels 13 through 17 corresponding to respective symbols on those reels which are positioned on the main liquid crystal panel 11B. This lottery program includes symbol weighing data for each of the five reels 13 through 17. The symbol weighing data shows correspondence relationships between the respective code numbers and one or a plurality of random number values within a predetermined number value range (for instance 0 through 255). The probability of lottery with respect to each symbol is set by associating one or a plurality of random number values to one code number. The random number values are drawn by lottery and symbols which have been finally identified from the random number values are re-positioned on the main liquid crystal panel 11B. In the slot machine 1 according to the first embodiment, reels are rotated synchronously during a free game. Accordingly, an identical code number is always drawn for each of the reels 13 through 17 for a free game.

The lottery program for determining the symbols to be positioned may also employ weighing data in which the predetermined random number range is associated to the symbol combination. In this case, first, the symbol combination is selected by lottery based on the lottery program, and thereafter, the symbol combination thus determined is repositioned in the main liquid crystal panel 11B.

The random number generation circuit 55 operates in accordance with the commands from the main CPU 52 and generates random numbers within a predetermined range. The sampling circuit 56 selects, by lottery, an arbitrary random number from the random numbers generated by the random number generation circuit 55 in response to a command from the main CPU 52. At the same time, the sampling circuit 56 inputs the random number thus selected to the main CPU 52. The clock pulse generation circuit 57 generates a reference clock for causing the main CPU 52 to operate. The divider 58 inputs a signal obtained by dividing the reference clock by a constant frequency to the main CPU 52.

The main control board 71 is connected to the touch panel 18. As was described above, the touch panel 18 is arranged at a front face of the main liquid crystal panel 11B and is adapted to identify a coordinate position of the portion that was touched by the player. Specifically, the touch panel 18 can discriminate the portion that the player has touched, and in what direction the touched portion was moved based on the coordinate position information that was thus identified. A signal in accordance with the above discrimination is then inputted to the main CPU 52 through the I/O port 59.

The main control board 71 is connected to the operation button 26, including a START button for commanding execution of a game, a COLLECT button, a BET button and the like. Accordingly, a signal in accordance with a depression operation of these buttons is inputted to the main CPU 52 through the I/O port 59.

The illumination effect driving circuit 61 outputs an effect signal for causing the light emitting portion 30 and the topper effect device 4 as mentioned above to perform illumination effects. The topper effect device 4 is connected in series with the illumination effect driving circuit 61 through the light emitting portion 30.

The hopper driving circuit 63 drives the hopper 64 under the control of the main CPU 52. As a result, the hopper 64 carries out an operation to payout coins to the coin tray 29. The payout completion signal circuit 65 receives coin amount value data from the coin detecting portion 24 to which it is connected. Then, when the received coin amount value has reached the set coin amount value, the payout completion signal circuit 65 inputs a signal that notifies completion of coin payout to the main CPU 52. The coin detecting portion 66 detects the number of coins that were paid out by the hopper 64 and then inputs coin amount value data showing the amount of coins that was detected to the payout completion signal circuit 65. The display portion driving circuit 67 controls the display operation of the respective display portions including the reels 13 through 17, a payout amount display portion 19 and the credit amount display portion 20 and the like.

The main control board 71 is connected to the sub-control board 72. As shown in FIG. 7, the sub-control board 72 carries out display control of the upper liquid crystal panel 11A in the upper display portion 10A and the main liquid crystal panel 11B in the variable display portion 10B, as well as output control of the audio outputted by the speaker 31, based on the commands received from the main control board 71. This sub-control board 72 is constituted on a separate circuit board from the circuit board that constitutes the main control board 71. The sub-control board 72 has a micro computer (hereinafter referred to as “sub-micro computer”) 73 which is provided as a main constituting element. Then, the sub-control board 72 has a sound source IC 78, a power amplifier 79, and an image control circuit 81. The sound source IC 78 controls the audio output from the speaker 31. The power amplifier 79 functions as an amplifier. The image control circuit 81 operates as a display control section for the upper liquid crystal panel 11A and the main liquid crystal panel 11B.

The sub-micro computer 73 has a sub-CPU 74, a program ROM 75, a work RAM 76 and I/O ports 77 and 80. The sub-CPU 74 carries out a control operation in accordance with a control command transmitted from the main control board 71. Although the sub-control board 72 does not have a clock pulse generation circuit, a divider, a random number generation circuit and a sampling circuit, it is constituted so as to execute sampling of random numbers based on an operation program of the sub-CPU 74. The program ROM 75 stores a control program to be executed by the sub-CPU 74. The work RAM 76 is constituted as a temporary memory to be used by the sub CPU 74 in executing the control program.

The image control circuit 81 has an image control CPU 82, an image control work RAM 83, an image control program ROM 84, an image ROM 86, a video RAM 87 and an image control IC 88. The image control CPU 82 determines the image to be displayed on the upper liquid crystal panel 11A and the main liquid crystal panel 11B based on the parameters set in the sub-micro computer 73 and the image control programs stored in the image control program ROM 84. For instance, the upper liquid crystal panel 11A displays a payout table and a help screen. The main liquid crystal panel 11B carries out scrolled display and stopped display of the respective symbols 21 through 24 concurrent with the rotation of the reels 13 through 17 in a base game and free game, with respect to the symbol display portion 12.

The image control program ROM 84 stores an image control program and various types of selection tables relating to display on the upper liquid crystal panel 11A and the main liquid crystal panel 11B. The image control work RAM 83 functions as a temporary memory to be used in execution of the image control program in the image control CPU 82. The image control IC 88 forms an image in accordance with the contents determined by the image control CPU 82 and then outputs the image thus formed to the upper liquid crystal panel 11A and the main liquid crystal panel 11B.

The image ROM 86 stores dot data for forming an image. The video RAM 87 functions as a temporary memory to be used by the image control IC 88 in forming an image.

Next, the base game and the free game which are carried out in the slot machine 1 having the above configuration will be described by referring to FIG. 8. First, the base game will be described. The base game is a slot game in which a predetermined symbol combination is repositioned on the main liquid crystal panel 11B, through the respective reels 13 through 17. More specifically, the player operates the operation button 26 to set the bet amount, and when he/she depresses the START button, a lottery process is executed to select, by lottery, the symbols that will be positioned in the symbol display portion 12. After the start button has been depressed and the reels 13 through 17 start rotating following the lapse of a predetermined period of time, symbol columns of respective reels 13 through 17 are displayed in a scrolled manner wherein the symbols 21 through 24 on each symbol column are displayed in a symbol arrangement order defined as first array (see FIG. 8 (1)). Then, after the lapse of a predetermined period of time, a total of fifteen symbols will be sequentially stopped and displayed in the symbol display areas 32 through 46, as shown in FIG. 8 (2).

Here, in the base game, various kinds of winning combinations are determined in advance based on the respective symbol combination re-positioned in the main liquid crystal panel 11B (see FIG. 4). If a symbol combination corresponding to the winning combination is realized through the symbols re-positioned in the symbol display areas 32 through 46, a gaming value obtained by multiplying the payout corresponding to the winning combination thus established by the bet amount is awarded to the player.

On the other hand, the free game carried out in the slot machine executed after the game mode has switched from the base game in a case where a winning combination, including five “JACK” symbols 21, has been positioned in the symbol display areas 32 through 46. After the game has been successively carried out by a predetermined number of times (for instance, five times), the free game terminates and the game mode switches again to the base game. With respect to the procedure of the game, the free game is the same as the base game, except that in the free game, gaming values (credits) corresponding to the bet amount are not consumed at the start of the game, and the game is continuously carried out automatically without requiring the player to operate the operation button 26. During the free game, however, symbol arrangement order of respective symbol columns displayed in a scrolled manner along rotation of the reels 13 through 17 is changed to second array so that symbols of each identical kind are positioned next to each other at each symbol column. Furthermore, during the free game, all the reels 13 through 17 are rotated synchronously and symbols of a kind are positioned next to each other with reference to a horizontal direction (i.e., in a state that symbols of a kind are positioned next to each other over reels) so that symbol columns are displayed in a synchronously scrolled manner (see FIG. 8 (3)).

As a result, as shown in FIG. 8 (4), symbols of a kind are positioned next to each other with reference to both a vertical direction and a horizontal direction. Accordingly, fifteen symbols of a kind are stopped and displayed in the symbol display portion 12 at the maximum.

Next, a main control program to be executed in the slot machine 1 according to the first embodiment will be described in detail while referring to the drawings. FIG. 9 is a flow chart showing a main control program.

First, when the power switch is turned on (upon power on), the main control board 71 activates the sub-control board 72 and the controller 51 executes an initial setting process at step (hereinafter referred to as S) 1. In the initial setting process, the main CPU 52 executes the BIOS stored in the ROM 54 and expands the compressed data incorporated in the BIOS in the RAM 53. In executing the BIOS that was expanded in the RAM 53, the main CPU 52 carries out a diagnosis and initialization of the different types of peripheral devices. Further, the main CPU 52 writes the game programs and the like from the ROM 54 into the RAM 53 to acquire payout rate setting data and country identification information. While executing the initial setting process, the main CPU 52 also carries out an authentication process with respect to each program.

Then, at step S2, the main CPU 52 sequentially reads the game programs and the like from the RAM 53 and executes these programs to carry out a main game process. The slot machine 1 according to the present embodiment carries out the game by executing this main game process. The main game process is repeatedly executed while power is supplied to the slot machine 1.

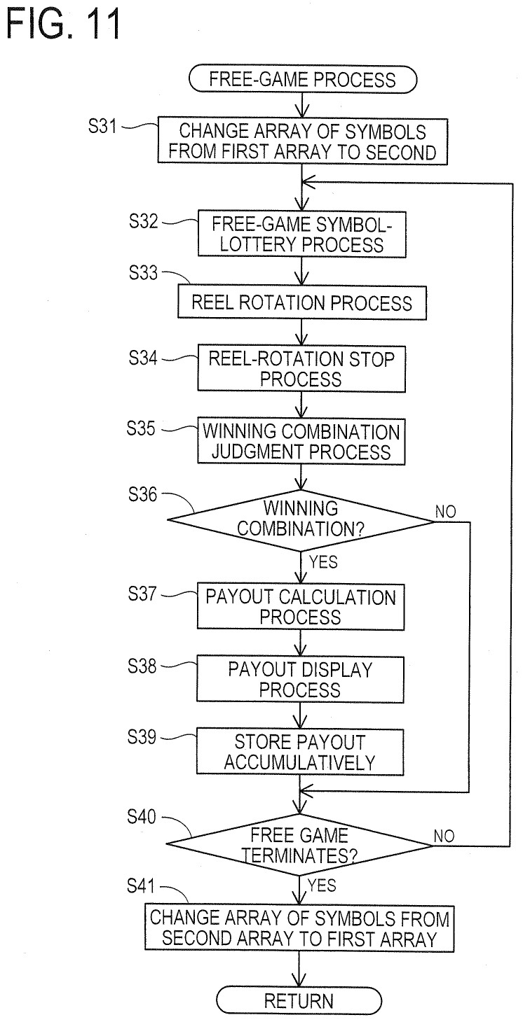

Next, a sub-process of the main game process at the above-described step S2 will now be described based on FIG. 10. FIG. 10 is a flow chart of a main game process program to be executed in the slot machine 1 according to the first embodiment. The programs shown in the flow charts at FIG. 10 and FIG. 11 as will be described later are stored in the ROM 54 and RAM 53 provided in the slot machine 1 and are executed in the main CPU 52.

As shown in FIG. 10, the main CPU 52 first executes a start acceptance process at step S11. In the start acceptance process, the player inserts coins and places a bet using the BET button from amongst the operation buttons 26.

At step S12, the main CPU 52 determines whether or not the start button from amongst the operation buttons 26 has been depressed. This determination is carried out based on the signal inputted to the main CPU 52 in response to depression of the start button. Here, if the start button has not been depressed (S12: NO), the flow returns to the start acceptance process (S11). As a result, the player can carry out an operation to correct, etc. the bet amount. Alternatively, if the start button has been depressed (S12: YES), the main CPU 52 subtracts the bet amount set based on the above-described bet operation from the credit amount that the player currently possesses and at the same time stores the result as bet information in the RAM 53.

At step S13, the main CPU 52 executes a symbol lottery process for the base game. In this symbol lottery process, the main CPU 52 selects, by lottery, the symbols to be positioned on the main liquid crystal panel 11B. More specifically, the main CPU 52 executes the lottery program stored in the RAM 53, thereby sampling a random number value from a number value range within a predetermined random number value range. The main CPU 52 determines the respective fifteen symbols (specifically, stop position of reels 13 through 17), from amongst the four kinds of scatter symbols 21 through 24, that will be re-positioned in the symbol display areas 32 through 46, based on the sampled random number value and the symbol weighing data.

Next, at step S14, the main CPU 52 carries out a reel rotation process. Specifically, the reels 13 through 17 start rotating and the symbol columns positioned in the respective reels 13 through 17 are displayed in a scrolled manner at a predetermined speed. Then, after the lapse of a predetermined period of time, the rotating reels 13 through 17 are stopped in turn, starting from the left, and one symbol is respectively displayed in each of symbol display areas 32 through 46 (see FIG. 8(2)). Thus, the symbol combination determined at the above-mentioned step S13 is re-positioned in the symbol display areas 32 through 46 of the main liquid crystal panel 11B.

Then, at step S15, the main CPU 52 carries out a winning determination process to determine whether the symbol combination positioned in the main liquid crystal panel 11B is any of the winning combinations for which a payout is awarded. This determination is carried out based on the code numbers of the respective reels 13 through 17 stored in the RAM 53.

If it is determined, at the above-mentioned step S15, that the winning combination has been established (S16: YES), the flow shifts to step S17. Alternatively, if it is determined that the winning combination has not been established (S16: NO), the main game process is ended. The processes following step S11 are carried out in the case a game is next started.

At step S17, the main CPU 52 calculates a payout based on the winning combination thus established. For instance, if a predetermined number or more of the same kind of symbols have been positioned, as shown in FIG. 4, a payout is calculated in accordance with the kind of symbol and the number of positioned symbols.

Next, at step S18, the main CPU 52 notifies the player by displaying the kind of the winning combination thus established and the contents of the payout with respect to the main liquid crystal panel 11B. For instance, if five “JACK” symbols 21 have been indicated, a message “WIN 10” and a message “Go Free Game” are displayed, as shown in FIG. 8(2). The former message notifies that 10 credits will be paid out as a payout, and the latter message notifies that the game mode shifts to a free game.

Next, at step S19, the main CPU 52 determines whether or not the trigger for shifting to the free game has been established. More specifically, if the winning combination including five “JACK” symbols 21 has been established, a determination is made that the trigger for shifting to the free game has been established.

As a result, if it is determined that the free-game shift trigger has been established (S19: YES), the value for the payout which will be awarded at present is stored (S20), and then, the flow shifts to the free game process (FIG. 11) as will be described later (S21). The payout which is stored at the above-described step S20 will be paid out at a payout process (S22) altogether with other payouts. Alternatively, if it is determined that the free-game shift trigger is not established (S19: NO), the flow shifts to step S22.

At step S22, the main CPU 52 awards a payout to the player in accordance with the winning combination established in the current game, based on the calculation result of the above-described step S17. At this time, the payout can be made using coins corresponding to the credit amount (1 credit corresponds to 1 coin), and the payout can be made by using bar-code attached tickets, in response to the depression of the CASHOUT button from among the operation buttons 26. If a free game has been carried out, a payout which was accumulated during the free game is paid out altogether to the player.

Next, the sub-process for the free game process at the above step S21 will be described based on FIG. 11. FIG. 11 is a flow chart of a sub-process program for the free game process in the slot machine 1 according to the first embodiment.

Firstly, at step S31, the main CPU 52 changes symbol arrangement order of respective symbol columns on the reels 13 through 17 from first array shown in FIG. 5 to second array shown in FIG. 1 wherein symbols of the each identical kind are positioned next to each other with respect to the symbols 21 through 24.

Next, at S32, the main CPU 52 executes a symbol lottery process for the free game in which symbols to be positioned on the main liquid crystal panel 11B are selected by lottery. The essential lottery process method is the same as the process at the above-mentioned step S13. However, in the slot machine 1 according to the first embodiment, all the reels are rotated synchronously during a free game and there is always drawn specific lottery to cause symbols of a kind to be re-positioned side by side in a horizontal direction.

Next, at step S33, the main CPU 52 carries out a reel rotation process. Specifically, the reels 13 through 17 start rotating and the respective symbol columns positioned in the respective reels 13 through 17 are displayed in a scrolled manner at a predetermined speed. When symbols are displayed in a scrolled manner, all the reels 13 through 17 are rotated synchronously in a state that symbols of a kind are displayed next to each other in a horizontal direction as well, as shown in FIG. 8 (3). Then, after the lapse of a predetermined period of time, the rotating reels 13 through 17 are stopped at the same time (S34) and one symbol is displayed in each of the symbol display areas 32 through 46 (see FIG. 8 (4)). As a result, the symbol combination as determined at the above-described step S32 is re-positioned in the symbol display areas 32 through 46 of the main liquid crystal panel 11B.

Then, at step S35, the main CPU 52 carries out a winning determination process in which a determination is made whether or not the symbol combination positioned on the main liquid crystal panel 11B is any of the winning combinations for which any of the payouts is awarded.

If it is determined at step S35, that the winning combination has been established (S36: YES), the flow shifts to step S37. Alternatively, if it is determined that the winning combination has not been established (S36: NO), the flow shifts to step S40.

At step S37, the main CPU 52 calculates the payout based on the winning combination thus established. For instance, if a predetermined number or more of the same kind of symbols have been positioned, as shown in FIG. 4, a payout is calculated in accordance with the kind of symbol and the number of positioned symbols.

Next, at step S38, the main CPU 52 sends a notification to the player by displaying the kind of the established winning combination and the contents of the payout with respect to the main liquid crystal panel 11B.

Next, at step S39, the main CPU 52 accumulatively stores a payout corresponding to the winning combination established in the current game in the RAM 53, based on the calculation results at the above-described step S37. The payout thus stored is awarded to the player altogether, after the free game ends (S22).

Then, at step S40, the main CPU 52 determines whether or not the free game completion condition has been satisfied. The free game completion condition in the slot machine 1 according to the first embodiment includes five times of free-game execution after shifting to the free game.

If it is determined that the free game completion condition has been satisfied (S40: YES), the flow shifts to step S41. Alternatively, if it is determined that the free game completion condition is not satisfied (S40: NO), the flow returns to step S32 at which the free game is then executed.

At step S41, the main CPU 52 changes symbol arrangement order of respective symbol columns on the reels 13 through 17 from second array shown in FIG. 1 to first array shown in FIG. 5 wherein respective kinds of symbols 21 though 24 are positioned randomly without regularity. After the game mode is switched from the free game to the base game, the flow shifts to step S22.

As described in the above text, in the slot machine 1 according to the first embodiment, when the base game is started, the respective reels 13 through 17 start rotating. Then, there are displayed symbol columns in first array in a scrolled manner wherein the symbols 21 through 24 of respective kinds on the each symbol columns are arranged randomly without regularity. After the lapse of a predetermined period of time, symbols are positioned in the symbol display areas 32 through 46 of the main liquid crystal panel 11B (S14). At this time, if a free-game shift trigger has been established (S19: YES9), the free game is executed (S21). When the free game is started, symbol arrangement order of respective symbol columns on the reels 13 through 17 is changed from first array shown in FIG. 5 to second array shown in FIG. 1 wherein symbols of the each identical kind are positioned next to each other with respect to the symbols 21 through 24 (S31). After that, all the reels 13 through 17 are rotated synchronously while symbols on the respective symbol columns are arranged in second array (S33). Thereby, the symbols 21 through 24 are displayed in a scrolled manner with symbols of each identical kind being collected over the reels, which enables the player to easily judge presence and absence of a combination which awards a prize. Furthermore, by employing the symbols 21 through 24 as scatter symbol, an apparent probability that symbols of the same kind are displayed is heightened and player's sense of expectancy to a free game is improved. Thereby, the entertainment characteristics of the slot machine can be improved.

### Second Embodiment

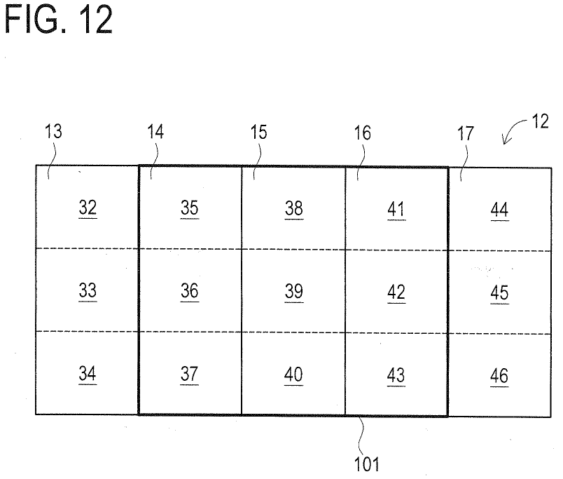

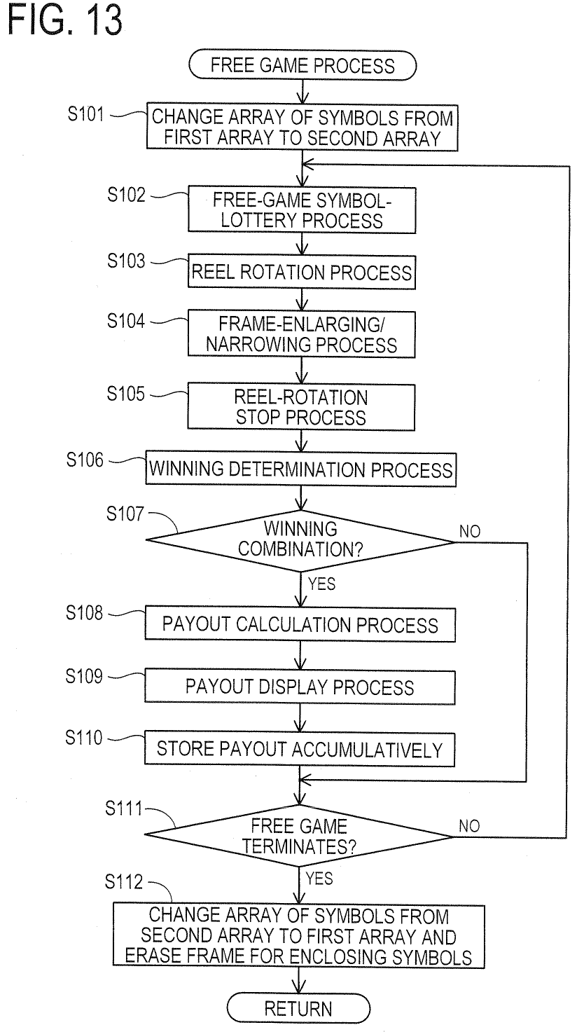

Next, a slot machine according to a second embodiment will be described based on FIG. 12 through FIG. 14. In the description to follow, reference characters which are the same as those for the configuration of the slot machine 1 according to the first embodiment as shown in FIG. 1 through FIG. 11 show the same or corresponding portions in the configuration of the slot machine 1 according to the first embodiment as was described hereinafter.

The schematic configuration of the slot machine according to the second embodiment is substantially the same as the slot machine 1 according to the first embodiment. The various kinds of control processes are substantially the same as those for the slot machine 1 according to the first embodiment.

The slot machine according to the second embodiment differs from the slot machine 1 according to the first embodiment in that a frame 101 for enclosing plural symbol display areas is indicated with reference to the symbol display portion 12 and the frame 101 is narrowed or enlarged after symbols are stopped and displayed so as to judge presence and absence of a winning combination based on a combination of symbols finally enclosed with the frame 101.

First, there will be described the symbol display portion 12 of the slot machine according to the second embodiment by referring to FIG. 12. In the slot machine according to the second embodiment, there is indicated the frame 101 which encloses one or plural symbol display areas among from the symbol display areas 32 though 46 constituting the symbol display portion 12 on the main liquid panel 11B. Furthermore, the frame 101 is enlarged or narrowed with a predetermined timing and the number of symbol display areas to be enclosed with the frame 101 is changed, as will be described later. Winning judgment is made based on a combination of symbols finally positioned within the frame 101.

Hereinafter, sub-processes for the free game process to be executed in the slot machine according to the second embodiment will be described based on FIG. 13. FIG. 13 is a flow chart for the free game process program in the slot machine according to the second embodiment.

Firstly, at step S101, the main CPU 52 changes symbol arrangement order of respective symbol columns on the reels 13 through 17 from first array shown in FIG. 5 to second array shown in FIG. 1 wherein symbols of the each identical kind are positioned next to each other with respect to the symbols 21 through 24. Furthermore, the main CPU 52 indicates the frame 101 which encloses one or plural symbol display areas among from the symbol display areas 32 though 46 constituting the symbol display portion 12 on the main liquid panel 11B. A size of the frame 101 is determined every time a free game is started, by carrying out a lottery process.

Next, at step S102, the main CPU 52 executes a symbol lottery process for the free game in which symbols to be positioned on the main liquid crystal panel 11B are selected by lottery. The specific lottery process contents are the same as the process (S32) carried out with the slot machine 1 according to the first embodiment. The detailed explanation thereof will be omitted.

Next, at step S103, the main CPU 52 carries out a reel rotation process. Specifically, the reels 13 through 17 start rotating and the symbol columns positioned on the respective reels 13 through 17 are displayed in a scrolled manner at a predetermined speed. When symbols are displayed in a scrolled manner, all the reels 13 through 17 are rotated synchronously in a state that symbols of a kind are displayed next to each other in a horizontal direction as well, which is similar to the first embodiment.

After that, at step S104, the main CPU 52 carries out either a frame-enlarging process or a frame-narrowing process so as to enlarge or narrow the frame 101 indicated in the symbol display portion 12 while symbols are being displayed in a scrolled manner. Type of process, namely a frame-enlarging process or a frame-narrowing process, and a size of the frame 101 after enlarging or narrowing are individually determined by lottery. When symbols are stopped and displayed, a prize is judged based on kind and number of symbols enclosed by the frame 101 that has been enlarged or narrowed at step S104.

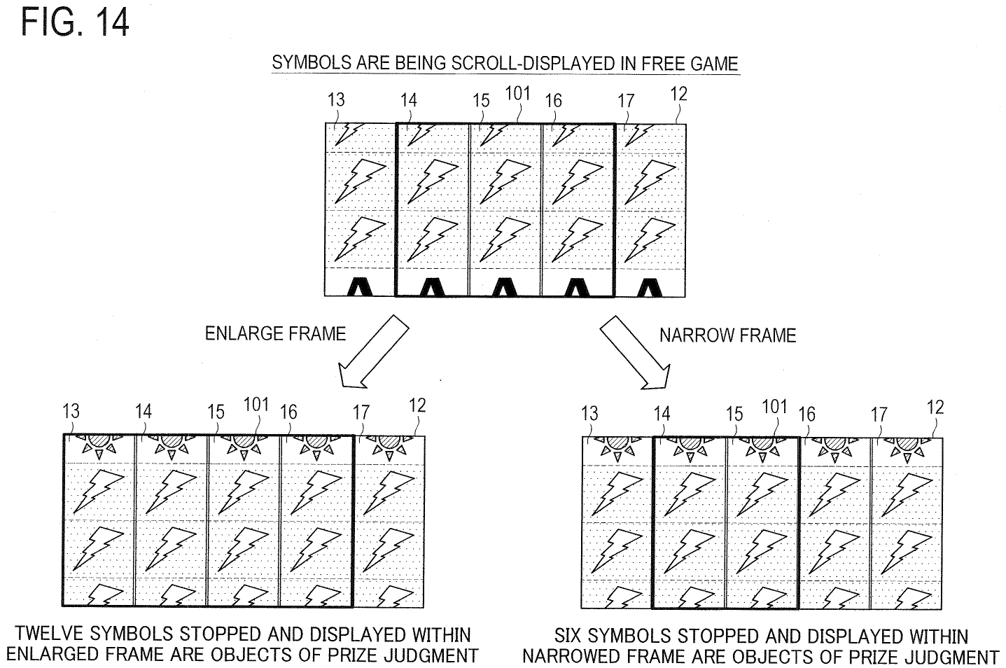

For instance, as shown in FIG. 14, in case the frame 101 enclosing the symbol display areas directed to the reels 14 through 16 has previously been indicated and a process to enlarge the frame 101 so as to further enclose the symbol display areas 32 through 34 directed to the reel 13 is carried out at step S104, winning judgment is made based on the twelve positioned within the enlarged frame 101.

On the other hand, in case the frame-narrowing process is carried out and the frame 101 is narrowed so as to exclude the symbol display areas 41 through 43 directed to the reel 16 at step S104, winning judgment is made based on the six symbols positioned within the narrowed frame 101.

Then, after the lapse of a predetermined period of time, the main CPU 52 stops rotation of the reels 13 through 17 simultaneously, and one symbol is respectively displayed in each of the symbol display areas 32 through 46.

Thereafter, the main CPU 52 carries out a winning determination process in which it is determined whether or not a combination of the symbol within the frame 101 among from symbols positioned in the main liquid crystal panel 11B is any of the winning combinations for which a payout is awarded.

If it is determined at step S106, that the winning combination has been established (S107: YES), the flow shifts to step S108. Alternatively, if it is determined that the winning combination has not been established (S107: NO), the flow shifts to step S111.

At step S108, the main CPU 52 calculates a payout based a combination of symbols enclosed with the frame 101. Specifically, in case a predetermined number or more symbols of a kind are positioned within the frame 101, payout is calculated based on the kind and number of positioned symbols as shown in FIG. 4. After that, the flow shifts to step S109.

The following processes S109 through S112 are respectively similar to S38 through S41 belonging to the free game process (FIG. 11) carried out with the slot machine 1 according to the first embodiment. Therefore, further description thereof will be hereby omitted. However, after the free game is terminated, a process to erase the frame 101 is additionally carried out (S112).

As described in the above text, in the slot machine according to the second embodiment, when a free game is started, symbol arrangement order of respective symbol columns on the reels 13 through 17 is changed from first array shown in FIG. 5 to second array shown in FIG. 1 wherein symbols of the each identical kind are positioned next to each other with respect to the symbols 21 through 24. Furthermore, there is indicated the frame 101 which encloses one or plural symbol display areas among from the symbol display areas 32 though 46 constituting the symbol display portion 12 (S101). Then, the frame 101 being indicated is enlarged or narrowed while symbols are displayed in a scrolled manner (S104). Then, a prized is awarded based on a combination of symbols positioned within the frame 101 when symbols are stopped and displayed. Thereby, prize contents can be diversified with size change of the frame in addition to positioning of symbols on the symbol display portion 12, which offers various amusement effects. Thereby, the entertainment characteristics of the slot machine can be improved.

### Third Embodiment

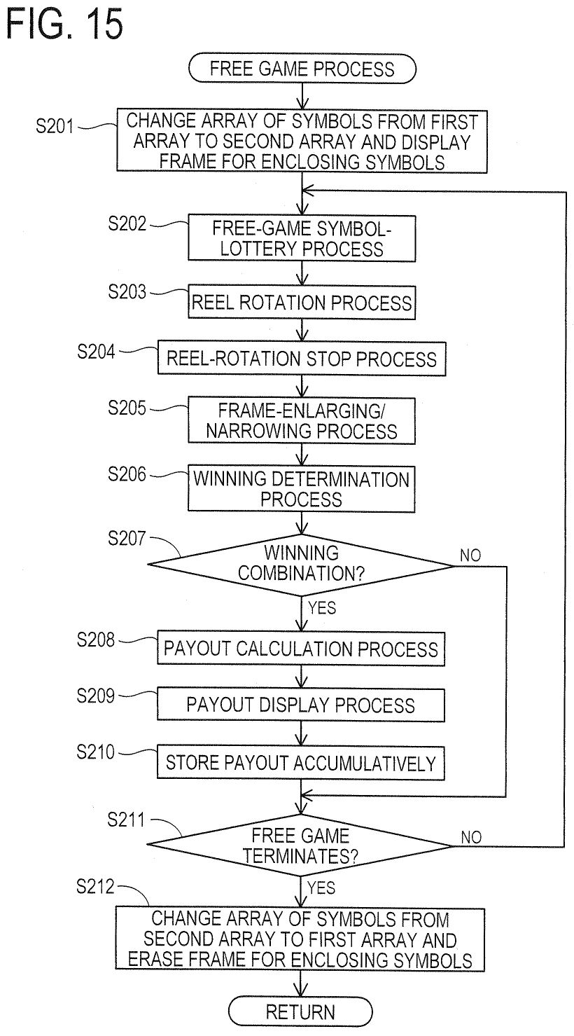

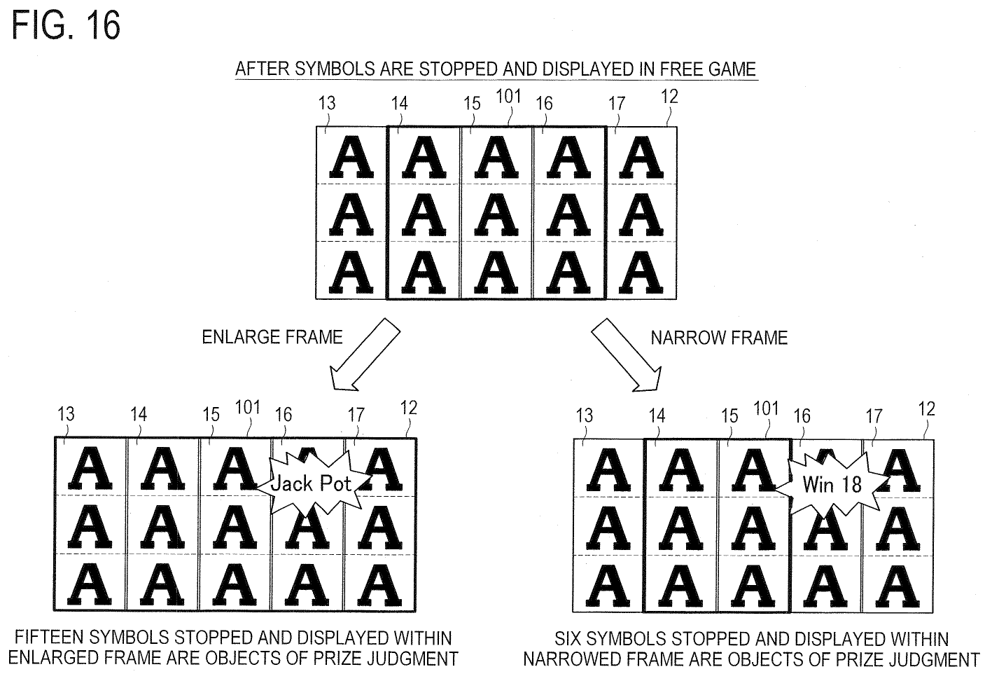

Next, the slot machine according to the third embodiment will now be described based on FIG. 15 and FIG. 16. In the description to follow, reference characters which are the same as those for the configuration of the slot machine 1 according to the first embodiment as shown in the FIG. 1 through FIG. 11 show the same or corresponding portions in the configuration of the slot machine 1 according to the first embodiment.

The schematic configuration of a slot machine according to the third embodiment is substantially the same as that of the slot machine 1 according to the first embodiment. The various kinds of control processes as well, are substantially the same as those in the slot machine 1 according to the first embodiment.

The slot machine according to the third embodiment differs from the slot machine 1 according to the first embodiment in that a frame 101 which encloses plural symbol display areas is indicated with reference to the symbol display portion 12 and the frame 101 is narrowed or enlarged after symbols are stopped and displayed so as to judge presence and absence of a winning combination based on a combination of symbols finally enclosed with the frame 101.

Hereinafter, sub-processes for the free game process to be executed in the slot machine according to the third embodiment will be described based on FIG. 15. FIG. 15 is a flow chart for the free game process program in the slot machine according to the third embodiment.

Firstly, at step S201, the main CPU 52 changes symbol arrangement order of respective symbol columns on the reels 13 through 17 from first array shown in FIG. 5 to second array shown in FIG. 1 wherein symbols of the each identical kind are positioned next to each other with respect to the symbols 21 through 24. Furthermore, the main CPU 52 indicates the frame 101 which encloses one or plural symbol display areas among from the symbol display areas 32 though 46 constituting the symbol display portion 12 on the main liquid panel 11B. A size of the frame 101 is determined every time a free game is started, by carrying out a lottery process.

Next, at S202, the main CPU 52 executes a symbol lottery process for the free game in which symbols to be positioned on the main liquid crystal panel 11B are selected by lottery. The specific lottery process contents are the same as the process (S32) carried out with the slot machine 1 according to the first embodiment. The detailed explanation thereof will be omitted.

Next, at step S203, the main CPU 52 carries out a reel rotation process. Specifically, the reels 13 through 17 start rotating and the symbol columns positioned in the respective reels 13 through 17 are displayed in a scrolled manner at a predetermined speed. When symbols are displayed in a scrolled manner, all the reels 13 through 17 are rotated synchronously in a state that symbols of a kind are displayed next to each other in a horizontal direction as well, which is similar to the first embodiment.

Then, after the lapse of a predetermined period of time, the rotating reels 13 through 17 are stopped at the same time (S204), and one symbol is respectively displayed in each of the symbol display areas 32 through 46.

Next, at step S205, the main CPU 52 carries out either a frame-enlarging process or a frame-narrowing process so as to enlarge or narrow the frame 101 indicated in the symbol display portion 12 after symbols are stopped and displayed. Type of process, namely a frame-enlarging process or a frame-narrowing process, and a size of the frame 101 after enlarging or narrowing are individually determined by lottery. A prize is judged based on kind and number of symbols finally enclosed by the frame 101 enlarged or narrowed at step S205.

For instance, as shown in FIG. 16, in case the frame 101 enclosing the symbol display areas directed to the reels 14 through 16 has previously been indicated and a process to enlarge the frame 101 so as to further enclose the symbol display areas 32 through 34 and 44 through 46 which respectively directed to the reel 13 and the reel 17 is carried out at step S205, winning judgment is made based on the fifteen symbols positioned within the enlarged frame 101.

On the other hand, in case the frame-narrowing process is carried out and the frame 101 is narrowed so to exclude the symbol display areas 41 through 43 directed to the reel 16 at step S205, winning judgment is made based on the six symbols positioned within the narrowed frame 101.

Thereafter, at step S206, the main CPU 52 carries out a winning determination process in which it is determined whether or not a combination of the symbol within the frame 101 among from symbols positioned in the main liquid crystal panel 11B is any of the winning combinations for which a payout is awarded.

If it is determined at step S206, that the winning combination has been established (S207: YES), the flow shifts to step S208. Alternatively, if it is determined that the winning combination has not been established (S207: NO), the flow shifts to step S211.

At step S208, the main CPU 52 calculates a payout based a combination of symbols enclosed with the frame 101. Specifically, in case a predetermined number or more symbols of a kind are positioned within the frame 101, payout is calculated based on the kind and number of positioned symbols as shown in FIG. 4. After that, the flow shifts to step S209.

The following processes S209 through S212 are respectively similar to S38 through S41 belonging to the free game process (FIG. 11) carried out with the slot machine 1 according to the first embodiment. Therefore, further description thereof will be hereby omitted. However, after the free game is terminated, a process to erase the frame 101 is additionally carried out (S212).

As described in the above text, in the slot machine according to the second embodiment, when a free game is started, symbol arrangement order of respective symbol columns on the reels 13 through 17 is changed from first array shown in FIG. 5 to second array shown in FIG. 1 wherein symbols of the each identical kind are positioned next to each other with respect to the symbols 21 through 24. Furthermore, there is indicated the frame 101 which encloses one or some symbol display areas among from the symbol display areas 32 though 46 constituting the symbol display portion 12 (S201). Next, the frame 101 being indicated is enlarged or narrowed after symbols are stopped and displayed (S205). Then, a prized is awarded based on a combination of symbols positioned within the frame 101 that has been enlarged/narrowed. Thereby, prize contents can be diversified with size change of the frame in addition to positioning of symbols on the symbol display portion 12, which offers various amusement effects. Thereby, the entertainment characteristics of the slot machine can be improved.

The present invention is not limited to the above-described embodiments and various modifications and alterations can be made thereto without departing from the scope of the present invention.

For instance, in the first through third embodiments, the conditions for shifting to the free game include establishment of a winning combination including a predetermined number or more of “JACK” symbols 21. However, the conditions for shifting to the free game may also include other conditions. For instance, such condition may occur unexpectedly, like a mystery.

In the first through third embodiment, symbol arrangement order of respective symbol columns on the reels 13 through 17 is changed by merely changing arrangement order without changing the number of each of the symbols 21 through 24 (i.e. without changing ratio of the respective symbols 21 through 24 per reel). However, the number of each of the symbols 21 through 24 may be changed. For instance, the number of “J” symbols 21 and that of “ACE” symbols 22 per reel may be increased.

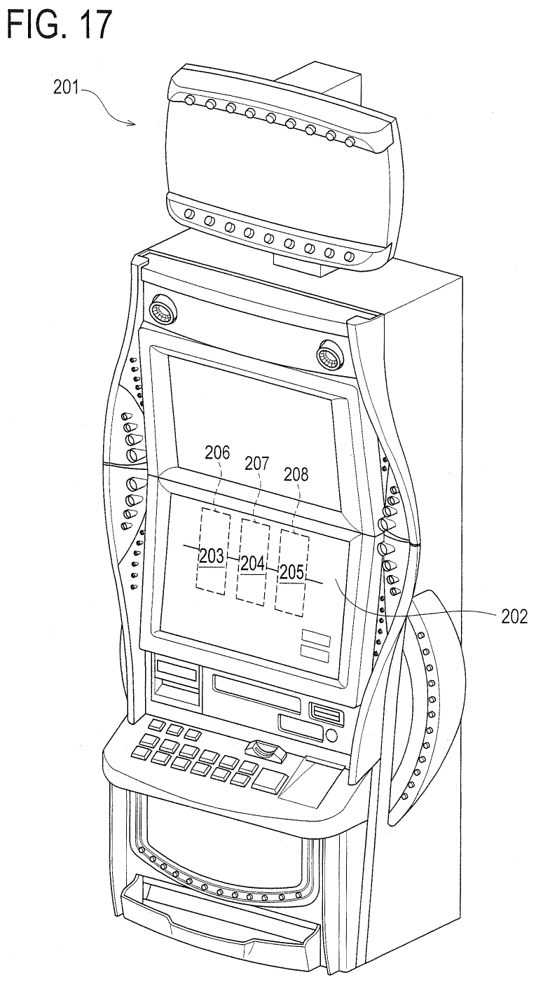

The present invention is not limited to video reels only, but is also applicable with respect to slot machines using mechanical reels. For instance, the slot machine 201 shown in FIG. 17 is a so-called hybrid-type slot machine having a heretofore known transparent liquid crystal panel installed at a front face of the plurality of mechanical reels which are rotatably supported, and a game is carried out therein by displaying images of the respective symbols positioned on the outer periphery of the mechanical reels, through the transparent liquid crystal panel.

The slot machine 201 has three reels, namely, a left reel 203, a center reel 204 and a right reel 205 which are rotatably supported. The respective reels 203 through 205 have symbol columns drawn on their outer periphery, each symbol column being made up of a plurality of symbols. Further, the respective reels 203 through 205 have, at a front side thereof, a main liquid crystal panel 202 which is made up of a heretofore known transparent liquid crystal panel provided in the main door. Here, the main liquid crystal panel 202 has three display windows 206, 207, and 208 formed therein, the back faces thereof being visible. On the outer periphery of the reels 203 through 205 are drawn symbol columns in accordance with the symbol arrangement order defined as first array as shown in FIG. 5.

In the above-described slot machine 201, the base game may be carried out employing the reels 203 through 205, while the free game may be carried out employing the video reels displayed in the main liquid crystal panel 202. Each of the video reels is made up of a symbol column wherein symbols thereon are arranged in accordance with the symbol arrangement order defined as second array as shown in FIG. 1.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A slot machine comprising:
a display that displays plural kinds of symbols; and
a processor that executes processes as follows:
(a) a process of displaying symbols in a scrolled manner during a base game, the symbols being arranged in accordance with a symbol arrangement order that is defined as first array;
(b) a process of executing a free game if a predetermined condition is satisfied during a base game;
(c) a process of changing symbol arrangement order from the first array to second array in which symbols of each identical kind are positioned next to each other when a free game is started; and
(d) a process of displaying symbols in a scrolled manner during a free game, the symbols being arranged in accordance with a symbol arrangement order that is defined as the second array.

2. A slot machine comprising:
plural reels each of which displays plural kinds of symbols in a scrolled manner and stops and displays any one or some of plural symbols;
a display that displays a the plural reels; and
a processor that executes processes as follows:
(a) a process of displaying symbols on the plural reels in a scrolled manner during a base game, the symbols being arranged in accordance with a symbol arrangement order that is defined as first array;
(b) a process of executing a free game if a predetermined condition is satisfied during a base game;
(c) a process of changing symbol arrangement order from the first array to second array in which symbols of each identical kind are positioned next to each other when a free game is started; and
(d) a process of rotating the plural reels synchronously during a free game in a state that symbols of each identical kind are positioned next to each other among the plural reels and displaying symbols on the plural reels in a scrolled manner during a free game, the symbols being arranged in accordance with a symbol arrangement order that is defined the second array.

3. A slot machine comprising:
plural reels each of which displays plural kinds of symbols in a scrolled manner and stops and displays any one or some of plural symbols;
a display that displays a the plural reels; and
a processor that executes processes as follows:
(a) a process of displaying a frame which encloses one or plural symbols displayed on the display;
(b) a process of displaying symbols on the plural reels in a scrolled manner during a base game, the symbols being arranged in accordance with a symbol arrangement order that is defined as first array;
(c) a process of executing a free game if a predetermined condition is satisfied during a base game;
(d) a process of changing symbol arrangement order from the first array to second array in which symbols of each identical kind are positioned next to each other when a free game is started;
(e) a process of rotating the plural reels synchronously during a free game in a state that symbols of each identical kind are positioned next to each other among the plural reels and displaying symbols on the plural reels in a scrolled manner during a free game, the symbols being arranged in accordance with a symbol arrangement order that is defined the second array; and
(f) a process of awarding a prize depending on symbols stopped and displayed within the frame.

4. The slot machine according to claim 3, wherein the processor executes a process of narrowing the frame during a free game.

5. The slot machine according to claim 3, wherein the processor executes a process of enlarging the frame during a free game.

6. The slot machine according to claim 4, wherein the processor executes a process of narrowing the frame while symbols are being displayed in a scrolled manner.

7. The slot machine according to claim 5, wherein the processor executes a process of enlarging the frame while symbols are being displayed in a scrolled manner.

8. The slot machine according to claim 4, wherein the processor executes a process of narrowing the frame after symbols are stopped and displayed.

9. The slot machine according to claim 5, wherein the processor executes a process of enlarging the frame after symbols are stopped and displayed.
